(19) United States
(12) Patent Application Publication
(10) Pub. No.: US 2022/0114210 A1
(43) Pub. Date: Apr. 14, 2022

(54) SOCIAL MEDIA VIDEO SHARING AND CYBERPERSONALITY BUILDING SYSTEM

(71) Applicant: SBL VENTURE CAPITAL, LLC, Los Angeles, CA (US)

(72) Inventor: Brian Kessler, Los Angeles, CA (US)

(21) Appl. No.: 17/469,854

(22) Filed: Sep. 8, 2021

Related U.S. Application Data
(60) Provisional application No. 63/148,708, filed on Feb. 12, 2021.
(60) Provisional application No. 63/075,775, filed on Sep. 8, 2020.

(51) Int. Cl. G06F 16/71; H04N 5/76; G10L 15/26; G06F 16/78

(52) U.S. Cl. CPC G06F 16/71; H04N 5/76; G06F 3/0488; G06F 16/7867; G10L 15/26

(57) ABSTRACT

A method for posting videos to an interactive media platform, includes recording audio-video content on a recorder, uploading the audio-video content to a social media application or interactive media platform, tagging the audio-video content with metadata, and uploading the video content and associated text file to the social media platform. The video can be made available for video responses from other users.

### BACKGROUND OF THE INVENTION

### Technical Field

The present invention relates to methods, apparatus, and systems for communication over social media platforms by video recordings. More specifically, the present invention relates to the sharing of videos through social media for the purpose of conversations eliciting a response by video recordings. while undertaking a live video transmission or recording session by instantly sharing videos.

### Background

Social media has permeated society at work and play. This includes platforms that allow text communications and video questions and answers or statements and responses (Video Q/A or S/R). One popular “app” is Tik Tok® which is a social media platform for creating, sharing and discovering short music videos. It is primarily used by young people express artistic talents through singing, dancing, comedy and lip-syncing.

### SUMMARY OF THE INVENTION

The invention provides a system for posting video questions or statements to an interactive media platform (also referred to as a social media platform) for the purpose of eliciting linked responsive videos.

In one general aspect, a method of posting video clips on an interactive media platform, includes recording audio-video content on a recorder, uploading the audio-video content to the interactive media platform, tagging the audio-video content with metadata and uploading the video content and associated text file to the interactive media platform.

Embodiments may include one or more of the following features. For example, the method may include translating the audio-video content to a text file, creating key words from the text file, and/or including the key words with the metadata.

As another feature, video responses to an initial video post and be linked to the initial video post and queued in a numerical order. A search engine may enable users to search for video content based on key words.

A software application may be downloaded onto users' electronic devices to utilize the interactive media platform. The interactive media platform may reside in a a cloud-based application.

The metadata for each video clip may include authorship, ownership, date, time, geographic location, file type and file size. Video responses may be linked based on topics and/or based on responses to particular video clips.

The user may user their electronic device, such as, for example, a smartphone with audio and video recorder to use the interactive media platform. Swiping left of right on the screen of the device may bring up linked conversations and swiping up or down may bring up the next topic and/or video clip.

Users may be prompted to post questions in a video clip which is then uploaded to a website for the interactive media platform. Users may also be prompted to post responses to the questions which are then linked together as a question and answers.

In another general aspect, an interactive media platform includes a database to store more than one audio-video clip, an audio to text converter to convert the audio from the audio-video clip to a text file, a keyword tagging engine to tag key words in the text file, a metadata tagging engine to tag the audio-video content with metadata and a website to post each audio-video clip along with audio-video responses linked each audio-video clip. Embodiments may include one or more of the above features.

### BRIEF DESCRIPTION OF THE DRAWINGS

FIG. 1 illustrates an interactive media platform.

FIGS. 2-16 illustrate the user's experience on an interactive media platform.

FIG. 17 illustrates multi-user engagement with the interactive media platform.

### DETAILED DESCRIPTION

The present invention relates to methods, apparatus, and systems for sharing video content and responsive videos on social media referred to as an interactive media platform.

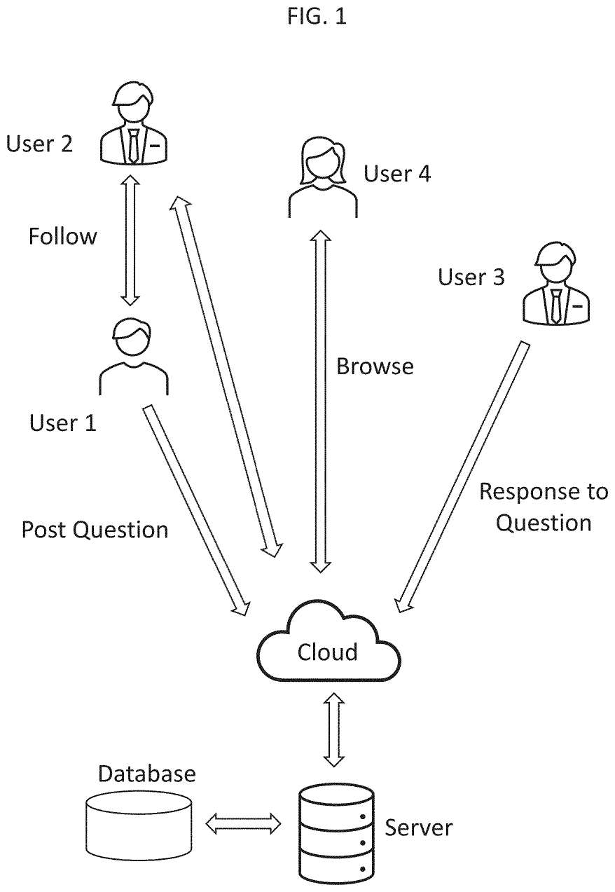

The interactive media platform is illustrated in FIG. 1. The interactive media platform resides on a server that accesses a database. Users (1, 2, 3 and 4) can access the interactive media platform through internet-based communications referred to as the cloud. The media platform and the database may also reside in the cloud.

User 1 has posted a question to the interactive media platform. User 1's question is made available to other users such as User 2 that follows User 1 as well as to User 3 and 4 that may be using the media platform's search engine to look up particular questions using keywords. User 4 posts an answer which is linked to User 1's question.

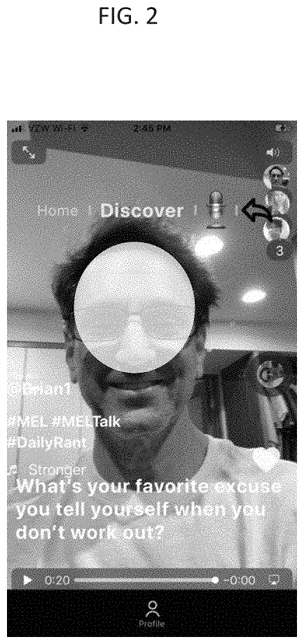

As an example, a user posts a video that asks a particular question or makes a particular state, such as, for example, “what is your favorite excuse for not working out?” A page is created with your video along with the question The question appears below the user's image as shown in FIG. 2.

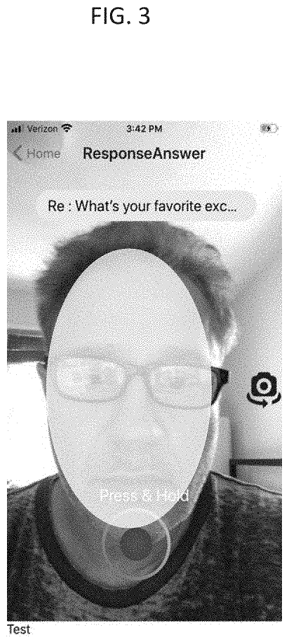

Other users hit play to view the video message or the video begins playing when you scroll onto the page. They can also view other recorded responsive videos by swiping left on the displayer screen. They can also post a responsive video of their own. The responder touches the arrow/reply button to respond which brings up a recording screen as shown in FIG. 3.

The user presses the red record button to record live. In one embodiment, the user has thirty (30) seconds to prepare the response video but other time limits may be implemented. As another feature the user may add pre-recorded videos or images. Each response is linked to the originating video and can be accessed by swiping left from the display of the originating video. Icons or a number showing users that most recently posted a response on the side of the display. The result is an initial video and follow-up responses that are linked together.

The videos are linked by an integration application that associates the follow-on videos with the initial video. The recording of video content is enabled by a simplified process. The video Q/A or S/R is then processed by the processing application such that the video Q/A or S/R s can be directly forwarded to and posted on the application website.

The recording process is enabled by tapping a microphone icon on the touch screen of the device. The camera of the device is activated by a record button on the touch screen button or swipe on a video touch display screen of a video capture device, such as, for example, a smartphone, laptop, computer or other portable imaging and communication device (referred to hereafter as smartphone or user device).

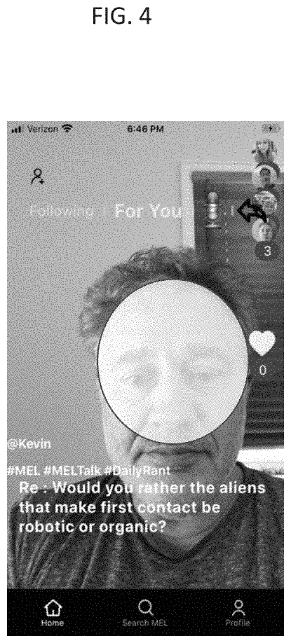

The application may enable the selection of a still image or animating image or link to another digitally accessible sight from the video Q/A or S/Rs. The still image is then posted along with the answer to the during playback of the recorded video content on the video display screen of the smartphone or on the video display screen of the external device as shown in FIG. 4.

The response can be accessed by touching the play icon at the bottom left of the screen or will automatically run when you land on the page and can be paused by tapping the screen.

The media integration application may be running the smartphone, an external device in communication with the smartphone, or on a web browser interface.

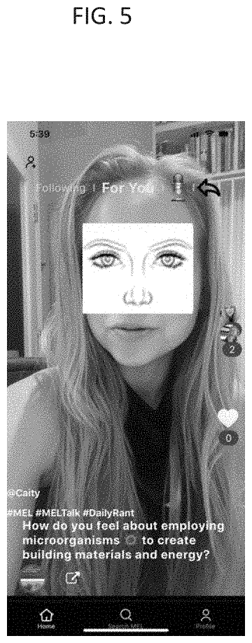

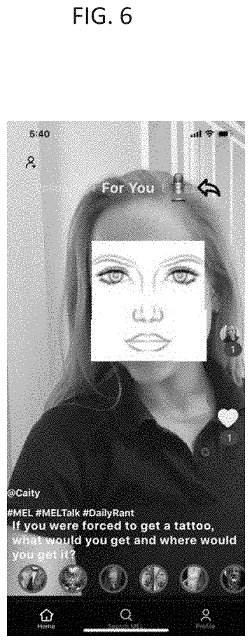

The circles indicate attachments or links. FIG. 5 illustrates one attachment and one link while FIG. 6 illustrates multiple image attachments.

The smartphone may be Internet enabled and the social media application may be running on the smartphone so the smartphone forwards the selected still images, graphics and the video Q/A or S/Rs to a social media website or a web browser interface via the Internet.

The application can have a language processor or other transcription tool to transcribe the audio to a text file. Metadata may be included with the video content and the text and metadata files are forwarded with the video to a social media website or a web browser interface. The metadata may include geographic location information of the video capture device (smartphone), date and time information of the recording, question or statement title, ownership information, image size information, the video Q/A or S/R size or length information, video format, and any additional metadata logged by the smartphone.

The video Q/A or S/Rs and associated text, metadata, still image and other files may be provided to the web browser interface. The Q/A or S/R files may be searchable via the web browser interface using the metadata information or the text file. The video Q/A or S/R files may be stored in a cloud-based storage and accessible via the web browser interface.

The video capture device (for example, smartphone) may be configured to periodically forward images or video Q/A or S/Rs to cloud-based storage or social media website for access by the web browser interface.

The digital backbone is like other social media platforms where people dialog back and forth on their platform. The social media sharing device of the current invention creates a virtual video dialog where by asking and answering questions and/or making statements and providing responses in video with imbedded text and graphic features it transforms typed word dialog into a virtual life like exchange of ideas that does not have to be done in real time. One person can start the virtual video dialog by asking a question or posing a statement which then allows anyone connected to their social network anywhere in the world to respond in video form to create a group virtual discussion.

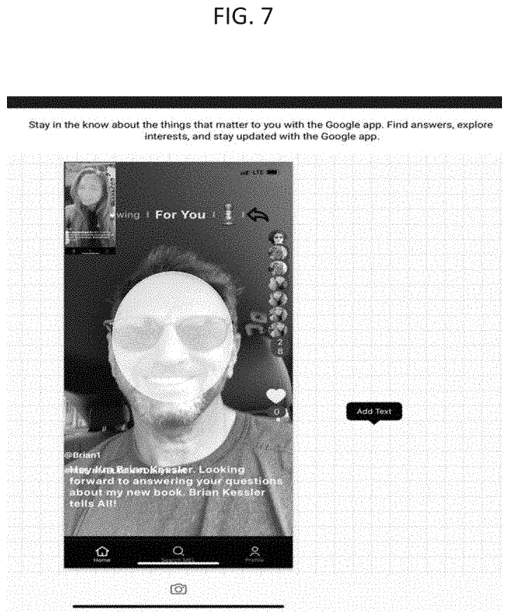

Referring to FIG. 7, the video ask/answer or statement/response format gives a completely different feel to digital communication. Different than an email, different then a text, different than any social media posting or platform. It gives a different feel then other video sharing platforms. Whereby marrying video around a question/answer and/or statement/response format and captured in a connected loop between question answers and responses, the invention creates a unique digital internet universe that creates a completely new way for people to interact. Social groups of all sizes can now share ideas in a unique and different and fun way then all other platforms. It offers unique solutions to two people sharing ideas, to small groups of people sharing unique ideas and conversations to them, and to large mass audience groups and gives a unique and new way to share ideas and conversations that has not existed before.

In addition to the closed loop question/answer and/or statement/response structure (the video Q/A or S/R) it is contemplated that a sub-set dialog can happen where a person can answer a person who has commented in a question or statement string and by tapping on the answering or responsive persons return button create a linked response to that person. That stays within the core question/answer and/or statement/response string but indicates to the individual that they have a personal response to their post within this question/statement string.

The person in the upper left corner is who is now linked to the person in the larger screen as response to the first person's response to the question or statement. It is contemplated that A viewer will be able to toggle back and forth between small images video and large images video. This sub response from original the video Q/A of S/R will be supported with a notification of the recipient that not only did someone respond to the original question/statement, but someone responded directly to your specific answer.

As another feature the string creator will be able to star and order a group of responses out of the attached string as they envision. Viewers can toggle between all answers as originally generated or see what the creator of the string creates as their grouping of the responses to the string. This gives an additional element of visual story telling or narrative that the application offers that has not existed on other social media applications.

A video and audio recording device, such as, for example, a smartphone or other user device, is connected to a network such as the Internet, a cellular telephone network, wide area network or local area network. A social media application is downloaded to the smartphone. The smartphone is connected to the cloud which includes application storage to store video Q/A or S/Rs. A social medial processing application is also in the cloud or is on a server connected to the cloud. In another embodiment, the network or cloud is connected to a dedicated server that includes storage and processing for the social media system.

A social media website with the video Q/A or S/Rs and other information is accessed through the network by way of a web browser interface. The social media website includes a variety of tools and information such as, for example, a one or more downloadable user applications, a login screen, platform information, general information, a search tool and video Q/A or S/Rs.

Images, graphics or video Q/A or S/Rs can be instantly on social media via a few simple button clicks. The present invention provides a simple method to contribute to social media by engaging people in conversations through a media-based platform.

The smartphone with camera or any other type of communication enabled video recording device is connected to a network such as the Internet or a cellular telephone network. A social media application is available from an “app” store, the social media website or other resource. The social media application is downloaded to the smartphone. The user creates an account with a username and one or more of a cellphone number, user image, email address or first and last name.

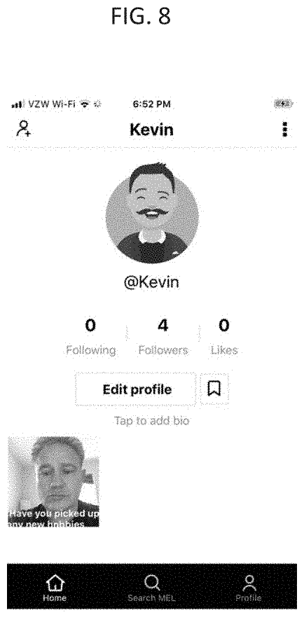

Referring to FIG. 8, the user has a profile screen in which he or she (hereafter their) can upload a personal image and add other personal information.

The user profile keeps a library of all video questions/statements and answers created by that user. The user information also includes likes, who they are following and the number of followers. Other users may be able to select the user's video Q/A or S/Rs from the profile page.

The user's live or recorded video content is processed by the cloud or server computer to create a still image, text file and metadata. These files are immediately uploaded and are then forwarded to the website interface or cloud storage.

The smartphone or user device may contain the necessary processor, memory and other hardware to run the processing application and connect to the network. Alternatively, if the recording device is, for example, a camera with a microphone, an external device may be connected to transfer data. The external device may have the processing application and/or the processing application is located on the web interface.

The simple touch process may be enabled by one of a push icon on the touch screen interface of the smartphone or a push button on the external device. One touch commands include the ability to create a new video or to reply to another's video.

Geographic location information may be provided by a GPS module on the smartphone.

The selected video Q/A or S/Rs are automatically uploaded to the web interface. Either still images, graphics or selected video Q/A or S/Rs can be posted to social media (either during live recording or local playback) by the push of the button 16. A length of the video Q/A or S/Rs may correspond to a length of time of touch the record button until the stop button is touched up to (in one current configuration) a maximum of thirty (30) seconds.

The text file and metadata associated with the video content is searchable. The metadata can include time, date, owner and ownership information, geographic location, event title, subject, keywords, image and file size, format, etc.

The question that is asked in the video can be from a digital transcription of an audio recording or it can be manually typed by the user.

A plurality of still images associated with each of the videos or video Q/A or S/Rs can be accessed by swiping up or down to access each recording. Responses to a video Q/A or S/Rs can be accessed by swiping left or right.

The video Q/A or S/Rs and Q/A or S/R responses may be searchable on the smartphone application or via the web browser interface using the metadata information or the text file. In another embodiment, a complete text file is created from the audio recording and the information in the text file is also searchable.

Search of the video Q/A or S/Rs and responses can be performed by using the metadata captured with the image or video Q/A or S/Rs, by date and time, geographic location, event name, or any other metadata information provided with the image or video Q/A or S/Rs as discussed above.

The user can interact with other members of the platform with varying degrees of distribution by marking a video as public, just friends, private group or diary post. For example, the user can mark a video Q/A or S/R for distribution to a public feed from MEL talk. The user can mark a video as private for distribution only to friends or a sub-group of friends. A user may also mark a video as a diary post, in which case, the video is only available to the user.

The user profile with all of their video Q/A or S/Rs provides a historical life log that can be used to create a storage “room” of each individual user on the site. These records along with other data can be used to mimic the personality of the user, referred to as a cyber person. The artificial personality learns from the user's recorded video questions asked and answers, facial expresses and behavior. Other psychographic information may be collected from responses to profiling questions.

User input is monitored for new content. The text files are parsed to convert conversational text into response data. The response data is passed to a knowledge learning engine. The learning engine intelligently interprets the response data to derive knowledge for building the cyber person. Images are parsed for facial expression and other details and passed to the knowledge learning engine.

The learning engine intelligently interprets the response data and parsed images to derive knowledge for building the cyber person. This includes the words that they use, their facial expressions, how they talk and how they think. The output from the learning engine is added to stored knowledge for the user.

The artificial intelligence system maps out a synapse pathway for future development of brain function and thought process of an individual. By utilizing pathways laid down by the question and answer structure designed within our social media video sharing platform our system can provide the backbone and architecture for future constructs that will allow the further integration of digital electronics and the working and mapping of the brain. To use the stored data as a foundation to lay out pathway charting. To use the stored data to interface with an owner to help train the software to feel the ones own personal approach to representing the data and establishing the way the user wants the system to represent themselves.

Under one of the configurations it is envisioned that in the user life log which is currently the user profile you will have a search engine. This will allow a viewer to ask a question for a profile or bring up a topic in the search engine and the result will show all stored data directly related to any topic that has been discussed as either a Q/A of S/R or a response by that individual profile. In turn giving a sampling of that profile's views provides a vast array of data related to that unique profile's perspectives.

The artificial intelligence system also allows for cross referencing similar interests amongst users and to sort and categorize information between users and within each user's data. It also improves key word searching. Other feature include pulling highly followed users up in the news feed and to use analytics like ‘likes’ and followers and views to create sharing of topics and posts with users across the MEL platform. The search engine can sort through questions, help find people, help find subjects, topics, areas of interest, what's trending, what popular, what's been popular. Searchable data can include polling data by geographic and numerous other socioeconomic data points to draw opinions by groups, by areas, by other breakdowns of topics for research purposes.

Searching can be used by using a person's username or unique identifier. A search can also be performed by username along with a topic or keyword. For example, the user be DrKessel and the topic may be concussions or concussions+football. The search result will return links to any video or responses to video in which DrKessel provides comments related to concussion.

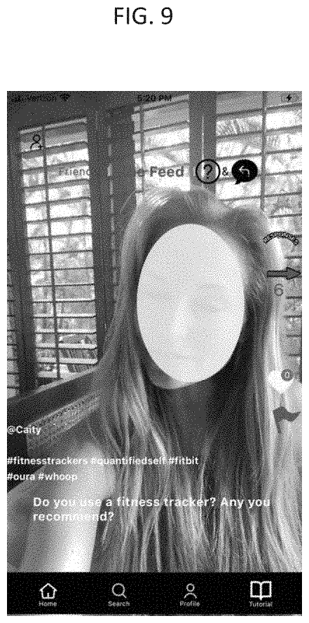

A linked set of videos is described with respect to the following images. A first user posts a comment or question about whether other users use fitness tracking equipment and what they might suggest. Referring to FIG. 9, The first user's video is initially labeled 1 but since there are five responses it is increments to 6.

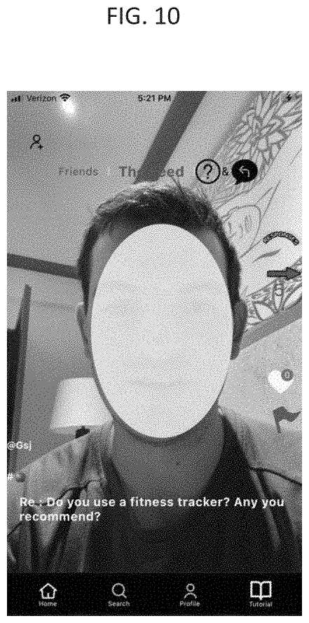

The next video by a second user is accessed by swiping left. The second user suggests a particular type of fitness tracking watch and why he likes to use it. Referring to FIG. 10, the second user video is labeled number 5.

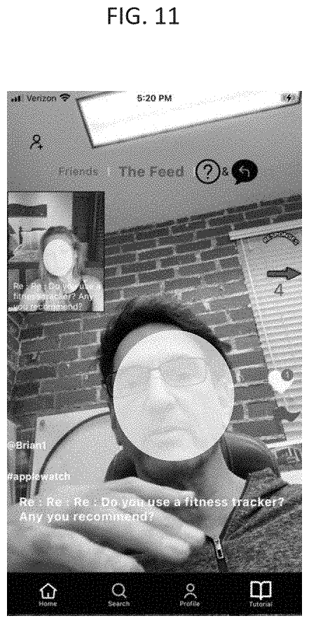

A third user posts a response which is accessed by swiping left again. The video is currently tagged as number 4. The third user responds with more detail about a particular fitness tracking product and its uses. Since third user is responding to first user, an image of first user and her question appear in the top left as shown in FIG. 11.

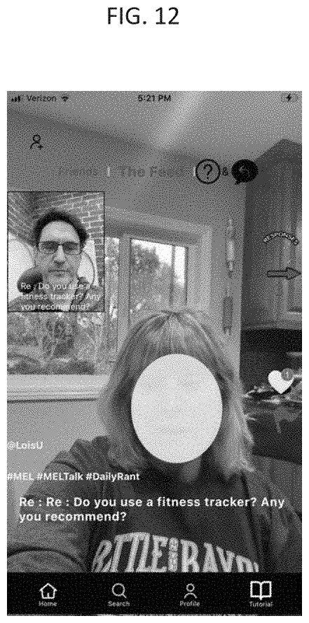

A fourth user video is accessed by once again swiping left. The video is tagged as number 3. The fourth user responds to the third user and explains why she does not use the device recommended by third user. Since fourth user is responding to third user, an image of the third user and the question appear in the top left as shown in FIG. 12.

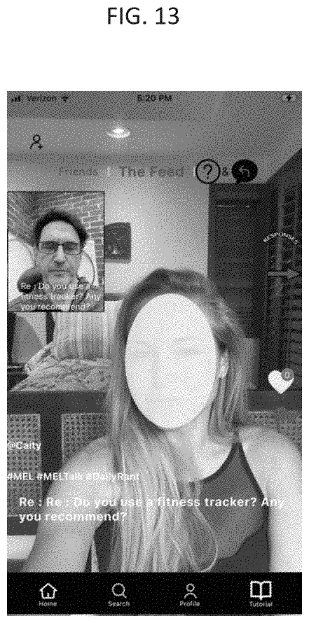

A follow-up video of the first user is accessed by swiping left which is now labeled as number 2. The first user decides to ask the third user some further questions about the product he (third user) recommended. As such, she requests more details. Since first user is requesting more details from third user, an image of the third user and the question appear in the top left as shown in FIG. 13.

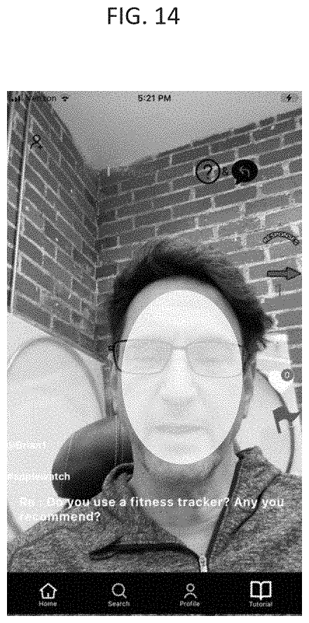

Third user responds with the detail requested by first user. Since this is the latest video in the series of linked videos it is labeled as number one as shown in FIG. 14.

Further features are imbedded into the program to provide the ability to effect posted video around the feel of a news production studio format. Some video social media platforms currently let you effect their videos or still pictures for both enhancement and fun effects. Though the social media invention incorporates some of that, it is primarily for giving unique video post-production and editing tools that will allow the “talking head” avatar to be enhanced like an on-air TV news broadcaster. So that if they are talking about a subject they can support their conversation with graphics, still images and videos like on the evening news or CNN.

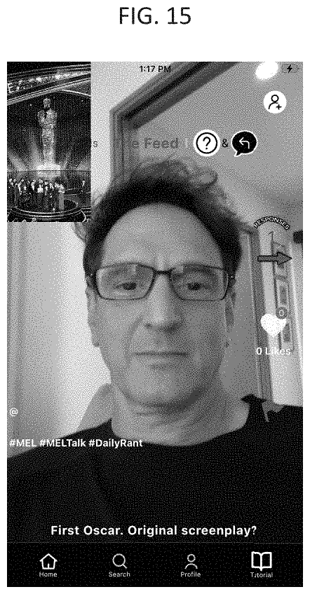

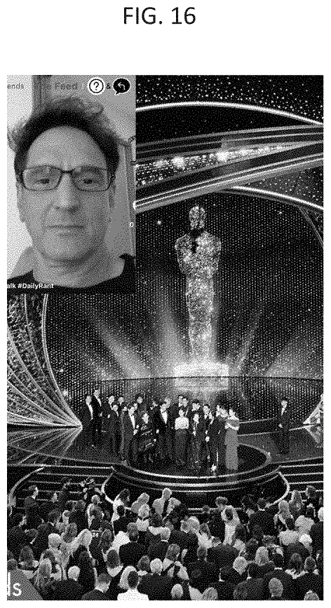

The interactive media platform can be utilized for user participation in events in real-time. As illustrated in FIG. 15, users can watch an event, such as, for example, the Oscars, and share their thoughts. The event may be watched on a separate media player or on a split screen or in a window on the user's page. Alternatively, the event may be watched and the user's home page may appear in a window on the event page as shown in FIG. 16.

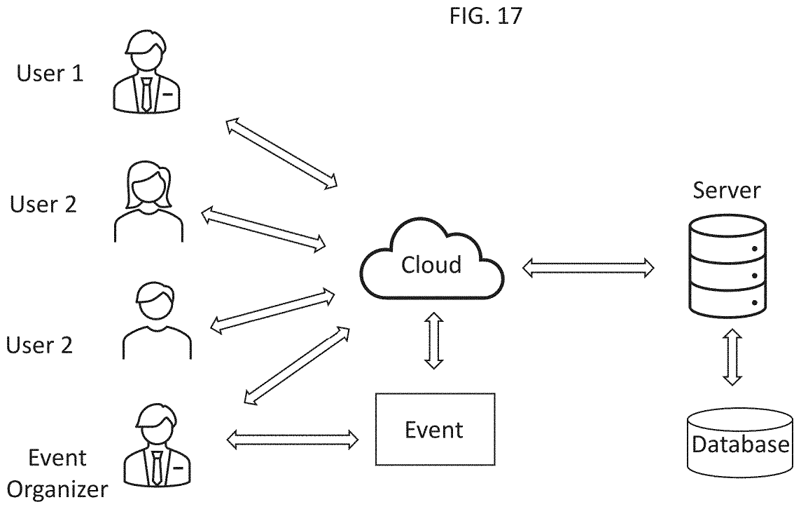

Referring to FIG. 17, users can participate in an event hosted or organized by an event organizer. The event organizer can set up the event and make it available to the users of the interactive media platform. Similar to FIG. 1, the interactive media platform resides in a server that access a database. Users (1, 2 and 3) can access the interactive media platform through cloud based internet communications.

Users that participate in the event hosted on the interactive media platform can get a non-fungible token (“NFT”) in return for their participation. The NFT may be, for example, a photograph, bitmap image, or video with unique features that can't be replaced with something else. NFTs can really be anything digital, such as, for example, your user history or brain downloaded and turned into artificial intelligence. Thus, the NFT can be used to authenticate a user's history and/or thoughts, memories, etc.

Each NFT can be traced back to its origin or creator since the NFT includes code that carries the form of its creator. This provided the possibility to authenticate the token on any browser or platform since it is a decentralized verification method that does not require any entity to host the NFT. The NFT provided from the interactive media platform can be unique to the event, person, time or place that the experience happens which gives it a unique identity from any other NFT ever created.

1. A method of posting video clips on an interactive media platform, comprising:
storing audio-video content from a user on a database;
tagging the audio-video content with metadata; and
uploading the video content and associated text file to a website for the interactive media platform.

2. The method of claim 1, further comprising:
translating the audio-video content to a text file.

3. The method of claim 1, further comprising:
creating key words from the text file; and
including the key words with the metadata.

4. The method of claim 1, further comprising:
queuing video responses to the video content in a numerical order.

5. The method of claim 1, further comprising:
enabling a user to search for the video content by the key words.

6. The method of claim 1, wherein the interactive media platform comprises a downloaded software application on the user's video recorder.

7. The method of claim 1, wherein the interactive media platform comprises a cloud-based application.

8. The method of claim 1, wherein the metadata comprises authorship, ownership, date, time, geographic location, file type and file size.

9. The method of claim 1, further comprising linking one topic to connected video responses.

10. The method of claim 1, further comprising enabling a swipe to the left or right to connect to the linked conversation. While also being able to swipe up or down to connect to the next topic.

11. The method of claim 1, further comprising:
prompting a user to post a question in a video clip;
uploading the video clip to the website for the interactive media platform.

12. The method of claim 11, further comprising:
prompting responses to the posted video clip;
uploading the responses to the posted media format with the responses linked to the question.

13. An interactive media platform, comprising:
a database to store more than one audio-video clip;
an audio to text converter to convert the audio from the audio-video clip to a text file;
a keyword tagging engine to tag key words in the text file;
a metadata tagging engine to tag the audio-video content with metadata; and
a website to post each audio-video clip along with audio-video responses linked each audio-video clip.
